(19) United States
(12) Patent Application Publication
(10) Pub. No.: US 2025/0192364 A1
(43) Pub. Date: Jun. 12, 2025

(54) SEPARATOR FOR RECHARGEABLE LITHIUM BATTERY AND RECHARGEABLE LITHIUM BATTERY

(71) Applicant: SAMSUNG SDI CO., LTD., Gyeonggi-do (KR)

(72) Inventors: Jinyoung KIM, Gyeonggi-do (KR); Minho CHO, Gyeonggi-do (KR); Hyeonseon CHOI, Gyeonggi-do (KR); Dongwan SEO, Gyeonggi-do (KR)

(73) Assignee: SAMSUNG SDI CO., LTD., Gyeonggi-do (KR)

(21) Appl. No.: 18/846,157

(22) PCT Filed: Feb. 20, 2023
(86) PCT No.: PCT/KR2023/002405

§ 371 Date: Sep. 11, 2024

(30) Foreign Application Priority Data
Apr. 15, 2022 (KR) 10-2022-0047171

(51) Int. Cl. H01M 50/446; H01M 10/0525; H01M 50/42; H01M 50/449

(52) U.S. Cl. CPC H01M 50/446; H01M 10/0525; H01M 50/42; H01M 50/449

(57) ABSTRACT

Disclosed are a separator for a rechargeable lithium battery, and a rechargeable lithium battery including the same, the separator for a rechargeable lithium battery including a porous substrate; a safety functional layer on at least one surface of the porous substrate; and an adhesive layer on the safety functional layer, wherein the safety functional layer includes polymer particles having a melting point of 100° C. to 200° C., an aqueous crosslinked binder, and inorganic particles, the aqueous crosslinked binder includes a crosslinked product of a poly(vinyl amide)-based copolymer, and the poly(vinyl amide)-based copolymer includes a unit derived from a vinyl amide monomer and a unit derived from a monomer including a crosslinkable group.

### TECHNICAL FIELD

A separator for a rechargeable lithium battery and a rechargeable lithium battery including the same are disclosed.

### BACKGROUND ART

A polyolefin micropore film is widely used as various separators for a battery, separation filters, membranes for microfiltration, and the like due to its chemical stability and excellent properties.

In recent times, with the trend toward high capacity and high power of rechargeable batteries, the demand for securing high strength and high permeability of the separators and also, improving their thermal safety and electrical safety is much increasing. A rechargeable lithium battery is required of high mechanical strength to improve safety in its manufacturing process and during the operation and also, required of high permeability and thermal safety to improve capacity and output. A separator, which has low thermal safety, may be damaged or deformed by a temperature increase inside the battery, which may cause a short circuit between electrodes, leading to explosion or firing of the battery.

In addition, with the recent technological development and increasing demand for batteries for electrical vehicles, as there is a need for a thin film separator due to the demand for improved current density and higher capacity of rechargeable lithium batteries mounted on the vehicles and also, a need for preventing battery explosion or firing due to abnormal reactions such as internal short circuit, overcharge, overdischarge, etc., there is an increasing demand for a high-performance but safe and thin film separator.

### DISCLOSURE

### Technical Problem

Provided are a separator for a rechargeable lithium battery that ensures high thermal and physical safety, exhibits excellent electrode adhesive force, and realizes high mechanical strength, permeability, and heat resistance, and a rechargeable lithium battery including the same.

### Technical Solution

In an embodiment, provided is a separator for a rechargeable lithium battery including a porous substrate; a safety functional layer on at least one surface of the porous substrate; and an adhesive layer on the safety functional layer, wherein the safety functional layer includes polymer particles having a melting point of 100° C. to 200° C., an aqueous crosslinked binder, and inorganic particles, the aqueous crosslinked binder includes a crosslinked product of a poly(vinyl amide)-based copolymer, and the poly(vinyl amide)-based copolymer includes a unit derived from a vinyl amide monomer and a unit derived from a monomer including a crosslinkable group.

In another embodiment, provided is a rechargeable lithium battery including a positive electrode, a negative electrode, the aforementioned separator between the positive electrode and the negative electrode, and an electrolyte.

### Advantageous Effects

A separator for a rechargeable lithium battery according to an embodiment has excellent thermal and mechanical safety, has high adhesive force to an electrode, and can realize high mechanical strength, permeability, and heat resistance. A rechargeable lithium battery including the same can achieve excellent cycle-life characteristics while ensuring thermal and physical safety.

### DESCRIPTION OF THE DRAWINGS

FIG. 1 is a cross-sectional view schematically showing a rechargeable lithium battery.

FIG. 2 is a graph showing impedance change according to temperature for the battery cells of Examples 1 to 4 and Comparative Example 1.

FIG. 3 is a graph showing changes in voltage and temperature over time in a bending safety evaluation for the battery cell of Example 1.

FIG. 4 is a photograph of the battery cell samples of Example 1 after completing the bending safety evaluation.

FIG. 5 is a graph showing changes in voltage and temperature over time in a bending safety evaluation for the battery cell of Comparative Example 1.

FIG. 6 is a photograph of the battery cell samples of Comparative Example 1 after completing the bending safety evaluation.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter and the average size may be measured by a method well known to those skilled in the art, for example, may be measured by a particle size analyzer, or may be measured by a transmission electron microscope photograph or a scanning electron microscope photograph. Alternatively, it is possible to obtain an average particle diameter value by measuring a size using a dynamic light scattering method, performing data analysis, counting the number of particles for each particle size range, and calculating from this. As used herein, when a definition is not otherwise provided, the average particle diameter may be may mean a diameter (D50) of particles measured by a particle size analyzer and having a cumulative volume of 50 volume % in the particle size distribution.

### Separator

In an embodiment, a separator for a rechargeable lithium battery includes a porous substrate; a safety functional layer on at least one surface of the porous substrate; and an adhesive layer on the safety functional layer. This separator may be referred to as a coated separator. In the separator, the safety functional layer includes polymer particles having a melting point of 100° C. to 200° C., an aqueous crosslinked binder, and inorganic particles. The aqueous crosslinked binder includes a crosslinked product of a poly(vinyl amide)-based copolymer, and the poly(vinyl amide)-based copolymer includes a unit derived from a vinyl amide monomer and a unit derived from a monomer including a crosslinkable group.

The separator according to an embodiment includes the above safety functional layer, thereby increasing resistance when the temperature of the battery rises, limiting the movement of lithium ions and electrons and making it difficult to flow current, and suppressing overheating and explosion of the battery. The safety functional layer does not interfere with the function of the battery at all under normal circumstances, but may function as a kind of insulating layer that suppresses heat generation of the battery only when the temperature of the battery rises. Additionally, the safety functional layer may be referred to as a PTC layer (positive temperature coefficient layer).

In addition, the separator includes an adhesive layer on the outermost surface, thereby strengthening adhesive force to the electrode and thereby realizing stable operation and long cycle-life characteristics of the rechargeable lithium battery. However, when applying an existing binder, for example, an aqueous non-crosslinked binder such as carboxymethyl cellulose, to the safety functional layer, when forming an adhesive layer on the safety functional layer, there is a problem in that the safety functional layer is separated due to the adhesive layer composition, making high-quality coating impossible. However, the separator according to an embodiment effectively solves the problem of detachment of the safety functional layer when forming an adhesive layer by applying an aqueous crosslinked binder, which is a crosslinked product of a poly(vinyl amide)-based copolymer, to the safety functional layer, thereby coating both the safety functional layer and the adhesive layer well, and thus improving thermal and physical safety and improving adhesive force to the electrode.

### Porous Substrate

The polyolefin used as a porous substrate material in the separator may be, for example, a homopolymer such as polyethylene or polypropylene, a copolymer, or a mixture thereof. Polyethylene may be low-density, medium-density, or high-density polyethylene, and from the viewpoint of mechanical strength, high-density polyethylene may be used. Additionally, two or more types of polyethylene can be mixed for the purpose of providing flexibility. From the viewpoint of achieving both mechanical strength and high permeability, the weight average molecular weight of polyethylene may be 100,000 to 12,000,000, for example, 200,000 to 3,000,000. The polypropylene can be a homopolymer, random copolymer, or block copolymer, and can be used alone or in a mixture of two or more. Also, stereoregularity is not particularly limited and isotactic, syndiotactic or atactic can be used, but inexpensive isotactic polypropylene can be used. Additionally, additives such as polyolefins other than polyethylene or polypropylene and antioxidants can be added to polyolefin.

The porous substrate may include, for example, polyolefin such as polyethylene or polypropylene, and a multilayer film of two or more layers, such as polyethylene/polypropylene two-layer separator, polyethylene/polypropylene/polyethylene three-layer separator, polypropylene/polyethylene/polypropylene three-layer separator, but it is not limited thereto, and any material and configuration that can be used as a porous substrate in the art may be possible.

The porous substrate may include, for example, a diene-based polymer prepared by polymerizing a monomer composition including a diene-based monomer. The diene-based monomer may be a conjugated diene-based monomer or a non-conjugated diene-based monomer. For example, the diene monomer may include one or more selected from 1,3-butadiene, isoprene, 2-chloro-1,3-butadiene, 2,3-dimethyl-1,3-butadiene, 2-ethyl-1,3-butadiene, 1,3-pentadiene, chloroprene, vinylpyridine, vinylnorbornene, dicyclopentadiene, and 1,4-hexadiene.

The thickness of the porous substrate may be 1 μm to 100 μm, for example, 1 μm to 30 μm, 5 μm to 20 μm, 5 μm to 15 μm, or 5 μm to 10 μm. If the thickness of the porous substrate is less than 1 μm, it may be difficult to maintain the mechanical properties of the separator, and if the thickness of the porous substrate is more than 100 μm, the internal resistance of the lithium battery may increase.

A porosity of the porous substrate may be 5% to 95%. If the porosity of the porous substrate is less than 5%, the internal resistance of the lithium battery may increase, and if the porosity is more than 95%, it may be difficult to maintain the mechanical properties of the porous substrate.

A pore size of the porous substrate may be 0.01 μm to 50 μm, for example, 0.01 μm to 20 μm, or 0.01 μm to 10 μm. If the pore size of the porous substrate is less than 0.01 μm, the internal resistance of the lithium battery may increase, and if the pore size of the porous substrate is greater than 50 μm, it may be difficult to maintain the mechanical properties of the porous substrate.

### Safety Functional Layer

The safety functional layer may be located on at least one surface of the porous substrate and includes polymer particles with a melting point of 100° C. to 200° C., an aqueous crosslinking binder, and inorganic particles.

A thickness of this safety functional layer is not particularly limited, but may be 5 length % to 45 length %, or 10 length % to 30 length % of the thickness of the porous substrate, based on the layer formed on one surface of the porous substrate, and for example, may be 0.1 μm to 5 μm, 0.5 μm to 4 μm, or 1 μm to 3 μm. In this case, the safety functional layer can improve safety and heat resistance without deteriorating the performance such as air permeability of the separator.

### Polymer Particles

In the safety functional layer, the polymer particles having a melting point (Tₘ) of 100° C. to 200° C. refer to a type of thermally expandable polymer that has the property of expanding or melting on its own when heat is applied. Such a thermally expandable polymer blocks a flow of current by self-expansion or fusion when the battery is overheated, reduces ion conductivity by closing the passage of ions, and as a result increases the resistance of the battery, ensuring the thermal safety of the battery.

The thermally expandable polymer can be used without restrictions as long as it expands or fuses at a temperature higher than room temperature. The thermally expandable polymer may expand from 70° C. to 200° C., and may be for example a polymer that expands over a temperature range of 70° C. to 180° C., 70° C. to 160° C., 80° C. to 200° C., 100° C. to 200° C., 100° C. to 180° C., or 100° C. to 160° C.

Additionally, the thermally expandable polymer may fuse at 100° C. to 200° C., and its melting point may be for example 100° C. to 180° C., 100° C. to 160° C., 100° C. to 140° C., or 110° C. to 130° C.

The polymer particles having the melting point of 100° C. to 200° C. may specifically include polyolefin, polystyrene, ethylene-vinyl acetate copolymer, ethylene-acrylic acid copolymer, ethylene-methacrylic acid copolymer, polytetrafluoroethylene, polyamide, polyacrylonitrile, thermoplastic elastomer, polyethyleneoxide, polyacetal, thermoplastic modified cellulose, polysulfone, (meth)acrylate copolymer, polymethyl(meth)acrylate, a copolymer thereof, or a combination thereof.

The polyolefin may be for example polyethylene, polypropylene, polymethylpentene, polybutene, their modifications, or a combination thereof. The polyethylene may specifically include high density polyethylene (density: 0.94 g/cc to 0.965 g/cc), medium density polyethylene (density: 0.925 g/cc to 0.94 g/cc), low density polyethylene (density: 0.91 g/cc to 0.925 g/cc), and very low density polyethylene (density: 0.85 g/cc to 0.91 g/cc), or a combination thereof. As an example, the polymer particles having the melting point of 100° C. to 200° C. may include polyethylene, polypropylene, or a combination thereof.

A weight average molecular weight (Mw) of the polymer particles having the melting point of 100° C. to 200° C. may be 1000 g/mol to 5000 g/mol, and for example, the weight average molecular weight (Mw) of the polyolefin or polyethylene may be 1000 g/mol to 5000 g/mol.

The polymer particles having the melting point of 100° C. to 200° C. may be, for example, spherical or plate-shaped, and their average particle diameter (D50) may be 50 nm to 5 μm, for example, 100 nm to 5 μm, 100 nm to 3 μm, 500 nm to 3 μm, 500 nm to 2 μm, 800 nm to 2 μm, or 1 μm to 2 μm. When the particle size of the polymer particles satisfies the above range, ion channels can be effectively closed even with a small amount. The average particle diameter may mean D50, which is the diameter of a particle with a cumulative volume of 50 volume % in the particle size distribution, and may be measured using a particle size analyzer, or through a photograph taken with an electron microscope such as SEM or TEM. Meanwhile, when the polymer particles are plate-shaped, the particle diameter may refer to a major axis length, which is a maximum length based on the widest side of the plate-shaped particle.

The polymer particles having a melting point of 100° C. to 200° C. may be included in an amount of 5 wt % to 95 wt %, for example 40 wt % to 90 wt %, 50 wt % to 90 wt %, or 60 wt % to 80 wt % based on 100 wt % of the safety functional layer. Within the above range, the safety functional layer can achieve excellent current blocking and ion blocking capabilities even with a thin thickness.

### Aqueous Crosslinked Binder

The aqueous crosslinked binder contains a crosslinking result of a poly(vinyl amide)-based copolymer, and may be formed through a reaction between a crosslinking reactive poly(vinyl amide)-based copolymer and a crosslinking agent during the formation of the safety functional layer. Herein, the crosslinking reactive poly(vinyl amide)-based copolymer can be simply referred to as poly(vinyl amide)-based copolymer. The poly(vinyl amide)-based copolymer includes a unit derived from a vinyl amide monomer and a unit derived from a monomer including a crosslinkable group. In the process of forming the safety functional layer, the crosslinking reactive group-containing monomer and the crosslinking agent react to form an aqueous crosslinked binder as a result of crosslinking. This aqueous crosslinked binder may also be expressed as a curable binder.

The vinylamide monomer may be selected from, for example, vinylpyrrolidone, vinylcaprolactam, N-vinylformamide, N-vinylacetamide, N-vinyl-N-methylacetamide, and a mixture thereof. As an example, the vinylamide monomer may be vinylpyrrolidone, and in this case, the copolymer may be called a poly(vinylpyrrolidone)-based copolymer, and accordingly, the binder may also be an aqueous crosslinkable poly(vinylpyrrolidone)-based binder.

For example, the crosslinkable group may be at least one selected from a carboxyl group, an amine group, an isocyanate group, a hydroxy group, an epoxy group, and an oxazoline group. For example, the crosslinkable group may be a carboxyl group. That is, the monomer including the crosslinkable group may be a carboxyl group-containing monomer. For example, the monomer including the crosslinkable group may include a carboxylic acid selected from acrylic acid, methacrylic acid, carboxyethyl acrylate, carboxypentyl acrylate, itaconic acid, maleic acid, fumaric acid, crotonic acid, isocrotonic acid, a monovalent metal salt of these acids, a divalent metal salt, an ammonium salt an organic amine salt, and a mixture thereof. For example, the monomer including the crosslinkable group may be acrylic acid, methacrylic acid, or a mixture thereof.

According to an embodiment, the poly(vinyl amide)-based copolymer may include a vinylpyrrolidone-derived unit and a (meth)acrylic acid-derived unit.

In the poly(vinyl amide)-based copolymer, an amount of the unit derived from the monomer including the crosslinkable group may be greater than 0 mol % and less than 50 mol %, and for example, 1 to 45 mol %, 5 to 40 mol %, or 10 to 30 mol % based on a total mole of monomer components constituting the poly(vinyl amide)-based copolymer. In this case, an appropriate level of crosslinking is possible, making it possible to manufacture a separator with guaranteed thermal and physical stability.

A weight average molecular weight of the poly(vinyl amide)-based copolymer may be, for example, 100,000 to 1,000,000 g/mol, for example, 150,000 to 800,000 g/mol, 200,000 to 700,000 g/mol, or 300,000 to 600,000 g/mol. Within the above range, it is possible to manufacture a separator that has low shrinkage even when stored at high temperatures and ensures high rigidity and high safety.

A glass transition temperature of the poly(vinyl amide)-based copolymer may be greater than or equal to 150° C., for example, 150° C. to 300° C., 170° C. to 280° C., or 190° C. to 250° C. Within the above range, a separator with improved safety can be manufactured.

According to an embodiment, the poly(vinyl amide)-based copolymer may be an aqueous crosslinking reactive polyvinylidene-acrylic acid-based copolymer.

The safety functional layer may further include a crosslinking agent. That is, the crosslinked product of a poly(vinyl amide)-based copolymer is crosslinked by a crosslinking agent, and specifically, it may be a product of a reaction between a monomer including a crosslinkable group and a crosslinking agent.

The crosslinking agent may be, for example, at least one selected from ethylene glycol diglycidyl ether, polyethylene glycol diglycidyl ether, glycerol polyglycidyl ether, propylene glycol diglycidyl ether, polypropylene glycol diglycidyl ether, ethylene glycol, Diethylene glycol, propylene glycol, triethylene glycol, tetraethylene glycol, propane diol, dipropylene glycol, polypropylene glycol, glycerin, polyglycerin, butanediol, heptanediol, hexanediol, trimethylene propane, pentaerythritol, and sorbitol.

An amount of the crosslinking agent may be 1 to 45 parts by weight, 1 to 40 parts by weight, 1 to 30 parts by weight, 1 to 20 parts by weight, or 5 to 15 parts by weight, based on 100 parts by weight of the poly(vinyl amide)-based copolymer. It is possible to produce a separator with guaranteed safety by achieving a desired level of crosslinking within the above range.

The aqueous crosslinked binder may be included in an amount of 0.1 wt % to 20 wt %, for example 0.1 wt % to 15 wt %, 0.5 wt % to 10 wt %, 1 wt % to 8 wt %, or 2 wt % to 5 wt % based on 100 wt % of the safety functional layer. Additionally, the aqueous crosslinked binder may be included in an amount of 1 part by weight to 20 parts by weight, for example 1 part by weight to 10 parts by weight based on 100 parts by weight of the polymer particles having a melting point of 100° C. to 200° C. Within the above range, the aqueous crosslinked binder can achieve high adhesive force and secure the performance reliability of the safety functional layer, thereby improving the thermal and physical safety and cycle-life characteristics of the rechargeable lithium battery.

### Inorganic Particles

The inorganic particles can reduce the possibility of a short circuit between the positive electrode and the negative electrode and prevent the separator from rapidly shrinking or deforming due to temperature rise. In other words, the safety functional layer can improve the safety of the battery by including inorganic particles.

The inorganic particles may be a metal oxide, a semi-metal oxide, or a combination thereof. Specifically, the inorganic particles may include alumina, titania, boehmite, barium sulfate, calcium carbonate, calcium phosphate, amorphous silica, crystalline glass particles, kaolin, talc, silica-alumina composite oxide particles, calcium fluoride, lithium fluoride, zeolite, molybdenum sulfide, mica, magnesium oxide and the like.

The inorganic particle may be for example Al₂O₃, SiO₂, TiO₂, SnO₂, CeO₂, NiO, CaO, ZnO, MgO, ZrO₂, Y₂O₃, SrTiO₃, BaTiO₃, MgF₂, Mg(OH)₂, or a combination thereof. For example, the inorganic particles may be alumina, titania, boehmite, barium sulfate, or a combination thereof.

The inorganic particles may be spherical, plate-shaped, fibrous, cubic, etc., but are not limited to these and may be any form usable in the art. For example, cubic boehmite can improve the heat resistance of the separator, secure a relatively large number of pores, and improve physical safety of the lithium battery.

When the inorganic particles are plate-shaped or fibrous, an aspect ratio of the inorganic particles may be about 1:5 to 1:100, for example, about 1:10 to 1:100, 1:5 to 1:50, or about 1:10 to 1:50. Additionally, the ratio of the length of the major axis to the minor axis on the flat surface of the plate-shaped inorganic particle may be 1 to 3 or 1 to 2. The aspect ratio and the ratio of the length of the major axis to the minor axis may be measured using an optical microscope. When the aspect ratio and the length range of the minor axis to the major axis are satisfied, the thermal shrinkage rate of the separator can be lowered, relatively improved porosity can be secured, and the physical stability of the lithium battery can be improved.

The average particle diameter of the inorganic particles may be 50 nm to 2 μm, for example, 100 nm to 1.5 μm, or 150 nm to 1 μm, 300 nm to 1 μm, 500 nm to 1 μm, 500 nm to 800 nm, or 600 nm to 700 nm. The average particle size is measured using a laser scattering particle size distribution meter (e.g., Horiba LA-920), and refers to a median particle size (D50) when 50% is accumulated from the small particle side in volume conversion. By using inorganic particles having an average particle diameter within the above range, the binding force between the safety functional layer and the porous substrate may be improved, and an appropriate porosity of the separator may be secured.

The inorganic particles may be included in an amount of 5 wt % to 40 wt %, for example 5 wt % to 30 wt %, 5 wt % to 25 wt %, or 10 wt % to 20 wt % based on 100 wt % of the safety functional layer. In addition, the inorganic particles may be included in an amount of 10 parts by weight to 50 parts by weight, for example, 10 parts by weight to 40 parts by weight, or 15 parts by weight to 35 parts by weight, based on 100 parts by weight of the polymer particles having the melting point of 100° C. to 200° C. Within this range, the inorganic particles can achieve high mechanical strength and high transmittance of the safety functional layer and the separator including it.

The safety functional layer may include 40 wt % to 90 wt % of the polymer particles having the melting point of 100° C. to 200° C.; 0.1 wt % to 20 wt % of the aqueous crosslinked binder; and 5 wt % to 40 wt % of inorganic particles based on 100 wt % of the safety functional layer. Alternatively, the safety functional layer may include 1 to 20 parts by weight of an aqueous crosslinking binder and 10 to 50 parts by weight of inorganic particles, based on 100 parts by weight of the polymer particles having the melting point of 100 to 200° C. In this case, the safety functional layer can be coated with high quality without detaching or collapsing during the manufacturing process, improves the thermal and physical safety of the separator and increases mechanical strength and transmittance, and improves the overall performance such as safety and cycle-life characteristics of the rechargeable lithium battery.

Meanwhile, the safety functional layer may further include an aqueous binder commonly used in the art, for example, an aqueous non-crosslinked binder. In this case, the safety functional layer can improve adhesive force and structural stability. The aqueous non-crosslinked binder may include, for example polyvinyl alcohol, polyvinylacetate, polyacrylic acid, polyacrylic acid ester, polymethacrylic acid, polymethacrylic acid ester, poly-N-vinylcarboxylic acidamide, polyacrylonitrile, polyether, polyamide, ethylene vinyl acetate copolymer, polyethyleneoxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxylmethyl cellulose, an acrylonitrile styrene butadiene copolymer, and polyimide.

The aqueous non-crosslinked binder may be included in an amount of 0.1 wt % to 10 wt %, for example 0.1 wt % to 8 wt %, 0.1 wt % to 6 wt %, 0.5 wt % to 4 wt %, or 0.5 wt % to 3 wt % based on 100 wt % of the safety functional layer. In addition, the aqueous non-crosslinked binder may be included in an amount of 0.1 parts by weight to 8 parts by weight, for example 0.5 parts by weight to 6 parts by weight, or 1 part by weight to 4 parts by weight, based on 100 parts by weight of the polymer particles having a melting point of 100° C. to 200° C. Within this range, the aqueous non-crosslinked binder can improve the adhesive force and structural stability of the safety functional layer.

When the safety functional layer further includes an aqueous non-crosslinked binder, based on 100 wt % of the safety functional layer, the safety functional layer may include 40 wt % to 90 wt % of the polymer particles having a melting point of 100° C. to 200° C.; 0.1 wt % to 15 wt % of the aqueous crosslinked binder; 5 wt % to 40 wt % of the inorganic particles; and 0.1 wt % to 10 wt % of the aqueous non-crosslinked binder based on 100 wt % of the safety functional layer. Alternatively, the safety functional layer may include 1 to 20 parts by weight of the aqueous crosslinked binder, 10 to 50 parts by weight of the inorganic particles, and 0.1 parts by weight to 8 parts by weight of the aqueous non-crosslinked binder based on 100 parts by weight of the polymer particles having the melting point of 100° C. to 200° C. In this case, the safety functional layer can further improve the thermal and physical safety of the separator and improve the overall performance of the battery.

Meanwhile, the safety functional layer may further include organic particles. The organic particle may be a crosslinked polymer, for example, a highly crosslinked polymer that does not exhibit a glass transition temperature. When a highly crosslinked polymer is used, heat resistance is improved and shrinkage of the porous substrate at high temperatures can be effectively suppressed. The organic particles may include, for example, a styrene-based compound and a derivative thereof, a methyl methacrylate-based compound and a derivative thereof, an acrylate-based compound and a derivative thereof, a diallyl phthalate-based compound and a derivative thereof, a polyimide-based compound and a derivative thereof, a polyurethane-based compound and a derivative thereof, a copolymer thereof, or a combination thereof, but are is not limited thereto, and any organic particle that can be used in the art may be used.

The organic particles may be, for example, crosslinked polystyrene particles or crosslinked polymethyl methacrylate particles, or may be in the form of secondary particles formed by agglomerating a plurality of primary particles. When the safety functional layer further includes organic particles in the form of secondary particles, the porosity of the separator can be increased, thereby providing a rechargeable lithium battery with excellent high output characteristics.

The organic particles may be included in an amount of 0.1 wt % to 20 wt %, or 0.1 wt % to 10 wt % based on 100 wt % of the safety functional layer. In this case, the organic particles can improve the heat resistance, permeability, durability, etc. of the safety functional layer and the separator including it.

### Adhesive Layer

The adhesive layer is located on the aforementioned safety functional layer. When the safety functional layer is located on both surfaces of the porous substrate, the adhesive layer is also disposed on both surfaces, and when the safety functional layer is located on only one surface of the porous substrate, the adhesive layer may be located only on one surface on which the safety functional layer is formed, or on both surfaces, i.e. on the surface on which the safety functional layer is formed and on the surface on which the safety functional layer is not formed. The adhesive layer is located on the outermost surface of the separator and can function to improve the adhesive force between the electrode and the separator.

In an embodiment, the adhesive layer may include at least one of an acrylic binder, a fluorine-based binder, and a polyvinyl alcohol binder. For example, the adhesive layer may include an acrylic binder and a fluorine-based binder. For example, the adhesive layer may include an acrylic binder, a fluorine-based binder, and a polyvinyl alcohol binder. Accordingly, the adhesive layer can greatly improve the adhesive force between the electrode and the separator and improve the cycle-life characteristics of the rechargeable lithium battery.

The acrylic binder included in the adhesive layer may include a type of acrylic copolymer, and the acrylic copolymer may be, for example, an acrylic copolymer including a unit derived from a (meth)acrylate monomer. In addition, the acrylic copolymer may further include a unit derived from an acetate group-containing monomer in addition to the unit derived from (meth)acrylate-based monomer. By using an acrylic copolymer having the unit derived from the (meth)acrylate monomer and/or the unit derived from the acetate group-containing monomer as a binder, the adhesive force between the separator and the electrode is improved and separation of the separator may be prevented during the electrode assembly manufacturing process to reduce process defect rates.

The glass transition temperature of the acrylic copolymer may be less than 100° C., for example, 20° C. to 60° C., specifically 30° C. to 45° C. Within the above range, shape stability can be secured by positioning the separator between the positive electrode and the negative electrode and achieving good adhesive force at the temperature at which it is pressed.

The acrylic copolymer is not particularly limited as long as it can form good adhesive force at the temperature at which the electrode assembly is pressed, but examples may be a copolymer produced by polymerizing one or more (meth)acrylate-based monomers selected from butyl (meth)acrylate, propyl (meth)acrylate, ethyl (meth)acrylate, and methyl (meth)acrylate. Alternatively, the acrylic copolymer may be a copolymer produced by polymerizing one or more (meth)acrylate monomers selected from butyl (meth)acrylate, propyl (meth)acrylate, ethyl (meth)acrylate, and methyl (meth)acrylate, and one or more acetate group-containing monomers selected from vinyl acetate and allyl acetate.

In the acrylic copolymer, a molar ratio of the (meth)acrylate monomer and the acetate group-containing monomer may be 3:7 to 7:3, for example, 4:6 to 6:4.

The fluorine-based binder included in the adhesive layer may be, for example, a polyvinylidene fluoride-based binder, and specific examples may include at least one selected from polyvinylidene fluoride homopolymer (PVDF), polyvinylidene fluoride-hexafluoropropylene (PVDF-HFP), polyvinylidene fluoride-trichloroethylene (PVDF-TCE), polyvinylidene fluoride-chlorotrifluoroethylene (PVDF-CTFE).

A weight average molecular weight (Mw) of this fluorine-based binder may be 500,000 to 1,500,000 g/mol, for example, 1,000,000 to 1,500,000 g/mol. For example, two or more types of fluorine-based binders with different weight average molecular weights can be mixed and used. For example, one or more types with a weight average molecular weight of less than or equal to 1,000,000 g/mol and one or more types with a weight average molecular weight of greater than or equal to 1,000,000 g/mol can be used. When a fluorine-based binder within the above molecular weight range is used, the adhesive force between the separator and the electrode is strengthened, thereby effectively suppressing heat-induced shrinkage of the heat-vulnerable porous substrate, and the electrolyte impregnation of the separator can be sufficiently improved, and thus the overall performance, including the output characteristics of the rechargeable lithium battery, can be improved.

When the adhesive layer includes both an acrylic binder and a fluorine-based binder, a weight ratio of the acrylic binder and the fluorine-based binder may be 1:1 to 1:6, for example, :1 to 1:5, or 1:1 to 1:4, for example, greater than 1:1 and less than 1:4, and specifically, may be in the range of 1:1.5 to 1:3.5, 1:2 to 1:3.5, or 1:2.5 to 1:3.5. Within the above range, not only high heat resistance but also excellent electrode adhesive force can be achieved, thereby improving the cycle-life characteristics of a lithium battery.

A thickness of the adhesive layer is not particularly limited, but may be 1 length % to 15 length %, or 1 length % to 10 length % of the thickness of the porous substrate, based on the thickness of the adhesive layer formed on one surface of the porous substrate, e.g. 0.05 μm to 3 μm, or 0.1 μm to 2 μm. The adhesive layer according to an embodiment has such a thin thickness that it does not deteriorate the performance of the separator and can exhibit excellent adhesive strength despite the thin thickness.

A total thickness of the safety functional layer and the adhesive layer may be less than or equal to 50%, for example, 10% to 50%, 20% to 50%, or 30 to 50% of the total thickness of the separator. In this case, it is possible to secure air permeability and structural stability while increasing the heat resistance, safety, and adhesive force of the separator.

### Method of Manufacturing Separator

In an embodiment, a method of manufacturing a separator includes a porous substrate is prepared; coating a safety functional layer composition including a polymer particles having a melting point of 100° C. to 200° C., a crosslinking reactive poly(vinyl amide)-based copolymer, a crosslinking agent, inorganic particles, and a water solvent on one or both surfaces of a porous substrate and performing heat treatment to provide a safety functional layer, coating an adhesive layer composition on the safety functional layer and drying it to form an adhesive layer.

The safety functional layer composition may further include an alcohol-based organic solvent, for example, one or more selected from methanol, ethanol, propanol, and butanol. The alcohol-based organic solvent is harmless to the body and have excellent drying properties, and thus mass production can be achieved without reducing productivity. For example, the water solvent and the alcohol-based organic solvent may be included in a volume ratio of 100:0 to 60:40, for example, 95:5 to 80:20, or 85:15 to 70:30. Within the above range, a safety functional layer composition with improved drying characteristics can be provided. It can be said that most of the solvent in the safety functional layer composition is volatilized during the heat treatment process.

First, the safety functional layer composition is coated on one or both surfaces of the porous substrate while moving the porous substrate. The method of coating the safety functional layer composition is not particularly limited, and may include, for example, one or more coating methods selected from forward roll coating method, reverse roll coating method, microgravure coating method, and direct metering.

Subsequently, the porous substrate coated with the safety functional layer composition may be moved into a dryer and heat treated by hot air. The moving speed of the porous substrate in the dryer may be a coating speed, but if the moving speed of the porous substrate is too slow, the inorganic particles in the safety functional layer may be mainly distributed at the interface between the safety functional layer and the porous substrate, which may reduce the binding force. If the moving speed of the porous substrate is too fast, inorganic particles may be distributed in large quantities on the surface rather than on the porous substrate, making it difficult to form an adhesive layer or reducing the binding force with the electrode.

The hot air supply speed within the dryer may be, for example, 10 to 50 m/s, 10 to 40 m/s, 10 to 30 m/s, or 10 to 20 m/s, and the drying completion speed may be greater than 15 m/s. In this case, it is possible to manufacture a separator with improved bending strength and peel strength while improving production speed.

The hot air drying temperature in the dryer may be, for example, 30 to 80° C., 35 to 75° C., 40 to 70° C., or 45 to 65° C. In this case, a separator with improved bending strength and peel strength can be manufactured. If the hot air drying temperature is too low, drying may proceed incompletely, and if the hot air drying temperature is too high, it is difficult to obtain a uniform coating layer structure due to rapid volatilization of the solvent.

The residence time of the porous substrate in the dryer may be, for example, 10 to 50 seconds, 10 to 45 seconds, 10 to 40 seconds, 10 to 35 seconds, or 10 to 30 seconds. If the residence time is too short, uniform phase separation may not be achieved, and if the residence time is too long, the porous substrate may shrink or the pores of the porous substrate may shrink.

The safety functional layer formed on the porous substrate in this way is structurally stable and can be stored for a long time with good quality without being detached or collapsed by the adhesive layer composition in the subsequent adhesive layer formation step.

The adhesive layer composition may include at least one selected from an acrylic binder, a fluorine-based binder, and a polyvinyl alcohol binder, and a water solvent, thereby improving the adhesive force between the separator and the electrode.

The adhesive layer composition may also further include an alcohol-based organic solvent in addition to water, for example, one or more selected from methanol, ethanol, propanol, and butanol. The alcohol-based organic solvent is harmless to the body and have excellent drying properties, and thus mass production can be achieved without reducing productivity.

the electrode assembly wound in the form of a jelly roll and including the separator disposed between the positive electrode and the negative electrode may have a bending strength of greater than or equal to 460 N, and the peel strength of greater than or equal to 0.3 N/m, and accordingly, energy density and cycle characteristics of rechargeable lithium batteries can be improved.

The safety functional layer and the adhesive layer may independently have a single-layer structure or a multi-layer structure. In a multi-layer structure, layers selected from organic layers, inorganic layers, and organic/inorganic layers may be arbitrarily arranged. The multi-layer structure may be a two-layer structure, a three-layer structure, or a four-layer structure, but is not necessarily limited to these structures and may be selected depending on the required composite separator characteristics.

The safety functional layer and the adhesive layer may independently include 0.3 to 0.4 large-diameter pores with a diameter of 500 nm to 1000 nm per 1 μm², and 0.5 to 1.5 small-diameter pores with a diameter of less than 500 nm per 1 μm². In this case, the separator can implement balanced air permeability. If the number of large-diameter pores in the separator is less than 0.3 and the number of small-diameter pores is more than 0.15, the air permeability of the separator may increase excessively and the internal resistance of the separator impregnated in the electrolyte solution increases accordingly, thereby reducing the cycle-life characteristics of the rechargeable lithium battery. If the number of large-diameter pores is greater than 0.4 and the number of small-diameter pores is less than 0.5, the air permeability of the separator may be excessively low, and accordingly, it is difficult to effectively suppress the growth of lithium dendrites that occur during charging and discharging, increasing the possibility of short circuits in lithium secondary batteries.

Herein, the air permeability refers to the Gurley air permeability, which measures the time it takes for 100 cc of air to pass through the separator, for example, according to JIS P-8117.

The safety functional layer and the adhesive layer may independently exhibit a porosity of 30% to 90%, for example, 35% to 80%, or 40% to 70%. Accordingly, an increase in the internal resistance of the separator can be prevented, and excellent high-rate capabilities and mechanical strength can be realized. The porosity is a volume occupied by pores in the total volume of each layer.

A coating amount of each of the safety functional layer and the adhesive layer may be 1.0 g/m² to 4.5 g/m², for example 1.2 g/m² to 4.5 g/m², 1.5 g/m² to 4.5 g/m², or 1.7 g/m² to 4.5 g/m². In this case, the separator can simultaneously provide improved heat resistance, peel strength, and bending strength.

### Rechargeable Lithium Battery

An embodiment provides a rechargeable lithium battery including a positive electrode, a negative electrode, the aforementioned separator between the positive electrode and the positive electrode, and an electrolyte.

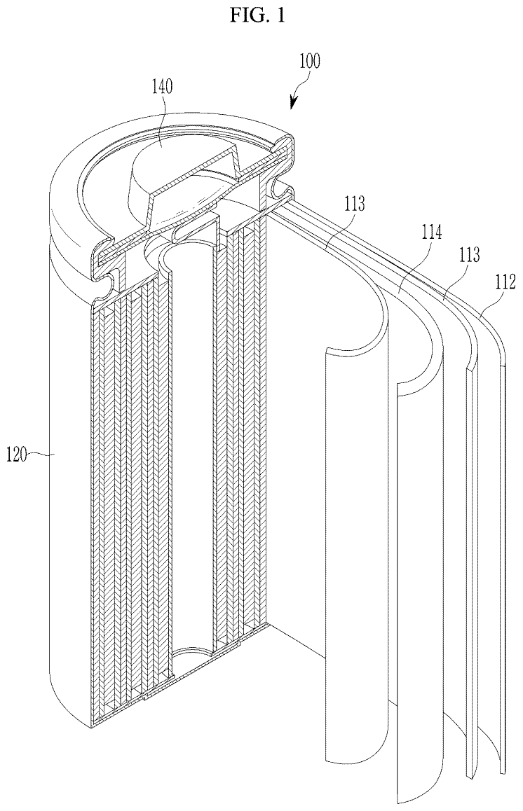

FIG. 1 is a schematic view showing a rechargeable lithium battery according to an embodiment. Referring to FIG. 1, the rechargeable lithium battery 100 according to an embodiment includes a battery cell including positive electrode 114, a negative electrode 112 facing the positive electrode 114, and a separator 113 between the positive electrode 114 and the negative electrode 112, and a electrolyte impregnating the positive electrode 114, the negative electrode 112, and the separator 113, a battery container 120 housing the battery cell, and a sealing member 140 that seals the battery container 120.

### Positive Electrode

The positive electrode 114 includes a current collector and a positive electrode active material layer on the current collector and the positive electrode active material layer includes a positive electrode active material and may optionally include a binder and/or a conductive material. Herein, the current collector may be, for example, aluminum foil, but is not limited thereto.

The positive electrode active material may include lithiated intercalation compounds that reversibly intercalate and deintercalate lithium ions. Examples of the positive electrode active material include compounds represented by any of the following Chemical Formulas:

LiₐA_{1-b}X_{b}D₂ (0.90≤a≤1.8, 0≤b≤0.5);

LiₐA_{1-b}X_{b}O_{2-c}D_{c} (0.90≤a≤1.8, 0≤b≤0.5, 0≤c≤0.05);

LiₐE_{1-b}X_{b}O_{2-c}D_{c} (0.90≤a≤1.8, 0≤b≤0.5, 0≤c≤0.05);

LiₐE_{2-b}X_{b}O_{4-c}D_{c} (0.90≤a≤1.8, 0≤b≤0.5, 0≤c≤0.05);

LiₐNi_{1-b-c}CO_{b}X_{c}D_{α} (0.90≤a≤1.8, 0≤b≤0.5, 0≤c≤0.5, 0<α≤2);

LiₐNi_{1-b-c}CO_{b}X_{c}O₂₋ₐT_{α} (0.90≤a≤1.8, 0≤b≤0.5, 0≤c≤0.05, 0<α<2);

LiₐNi_{1-b-c}CO_{b}X_{c}O₂₋ₐT₂ (0.90≤a≤1.8, 0≤b≤0.5, 0≤c≤0.05, 0<α<2);

LiₐNi_{1-b-c}Mn_{b}X_{c}D_{α} (0.90≤a≤1.8, 0≤b≤0.5, 0≤c≤0.05, 0<α≤2);

LiₐNi_{1-b-c}Mn_{b}X_{c}O_{2-α}T_{α} (0.90≤a≤1.8, 0≤b≤0.5, 0≤c≤0.05, 0<a<2);

LiₐNi_{1-b-c}Mn_{b}X_{c}O_{2-α}T₂ (0.90≤a≤1.8, 0≤b≤0.5, 0≤c≤0.05, 0<α<2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}GeO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}G_{b}O₂ (0.90≤a≤1.8, 0.001≤b≤0.1);

LiₐMn₂G_{b}O₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂(PO₄)₃ (0≤f≤2);

Li_{(3-f)}Fe₂(PO₄)₃ (0≤f≤2);

LiₐFePO₄ (0.90≤a≤1.8).

In the above chemical formulas, A is selected from Ni, Co, Mn, and a combination thereof; X is selected from Al, Ni, Co, Mn, Cr, Fe, Mg, Sr, V, rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be a lithium-metal composite oxide, for example, lithium cobalt oxide (LCO), lithium nickel oxide (LNO), lithium nickel cobalt oxide (NC), lithium nickel cobalt aluminum oxide (NCA), and lithium nickel cobalt manganese oxide (NCM), lithium manganese oxide (LMO), or lithium iron phosphate (LFP).

The compound having a coating layer on the surface may be used, or a mixture of the above compound and a compound having a coating layer may be used. This coating layer may include at least one coating element compound selected from an oxide of the coating element, a hydroxide of the coating element, an oxyhydroxide of the coating element, an oxycarbonate of the coating element, and a hydroxycarbonate of the coating element. The compound forming the coating layer may be amorphous or crystalline. The coating element included in the coating layer may include Mg, Al, Co, K, Na, Ca, Si, Ti, V, Sn, Ge, Ga, B, As, Zr, or a combination thereof. As an example, the coating layer may include lithium zirconium oxide (e.g., Li₂O—ZrO₂). The coating layer formation process may use a method that do not adversely affect the physical properties of the positive electrode active material, such as spray coating, dipping, dry coating, atomic vapor deposition, or evaporation.

The positive electrode active material may include, for example, one or more types of lithium-metal composite oxides represented by Chemical Formula 11.

LiₐM¹¹_{1-y11-z11}M¹²_{y11}M¹³_{z11}O₂ [Chemical Formula 11]

In Chemical Formula 11, 0.9≤a≤1.8, 0≤y11≤1, 0≤z11≤1, 0≤y11+z11<1, and M¹¹, and M¹² and M¹³ are independently any one selected from elements such as Ni, Co, Mn, Al, Mg, Ti, or Fe, and the like, and a combination thereof.

For example, M¹¹ may be Ni, and M¹² and M¹³ may independently be metals such as Co, Mn, Al, Mg, Ti, or Fe. In a specific embodiment, M¹¹ may be Ni, M¹² may be Co, and M¹³ may be Mn or Al, but are not limited thereto.

In an embodiment, the positive electrode active material may include a lithium nickel-based composite oxide represented by Chemical Formula 12.

Liₐ₁₂Niₓ₁₂M¹⁴_{y12}M¹⁵_{1-x12-y12}O₂ [Chemical Formula 12]

In Chemical Formula 12, 0.9≤a12≤1.8, 0.3≤x12≤1, 0≤y12≤0.7, and M¹⁴ and M¹⁵ are independently at least one element selected from Al, B, Ba, Ca, Ce, Co, Cr, F, Fe, Mg, Mn, Mo, Nb, P, S, Si, Sr, Ti, V, W, and Zr.

For example, the positive electrode active material may include lithium nickel cobalt-based oxide represented by Chemical Formula 13.

Liₐ₁₃Niₓ₁₃CO_{y13}M¹⁶_{1-x13-y13}O₂ [Chemical Formula 13]

In Chemical Formula 13, 0.9≤a13≤1.8, 0.3≤x13≤1, 0≤y13≤0.7 and M¹⁶ is at least one element selected from Al, B, Ba, Ca, Ce, Cr, F, Fe, Mg, Mn, Mo, Nb, P, S, Si, Sr, Ti, V, W, and Zr.

In Chemical Formula 13, 0.3≤x13≤0.99, and 0.01≤y13≤0.7, 0.4≤x13≤0.99 and 0.01≤y13≤0.6, 0.5≤x13≤0.99, and 0.01≤y13≤0.5, 0.6≤x13≤0.99 and 0.01≤y13≤0.4, 0.7≤x13≤0.99, and 0.01≤y13≤0.3, 0.8≤x13≤0.99 and 0.01≤y13≤0.2, or 0.9≤x13≤0.99, and 0.01≤y13≤0.1.

A nickel content in the lithium nickel-based composite oxide may be greater than or equal to 30 mol %, for example, greater than or equal to 40 mol %, greater than or equal to 50 mol %, greater than or equal to 60 mol %, greater than or equal to 70 mol %, greater than or equal to 80 mol %, or greater than or equal to 90 mol %, and may be less than or equal to 99.9 mol %, or less than or equal to 99 mol % based on a total amount of metals excluding lithium

For example, the nickel content in the lithium nickel-based composite oxide may be higher than the content of each other metal, such as cobalt, manganese, and aluminum. When the nickel content satisfies the above range, the positive electrode active material can achieve high capacity and exhibit excellent battery performance.

The average particle diameter (D50) of the positive electrode active material may be 1 μm to 25 μm, for example, 4 μm to 25 μm, 5 μm to 20 μm, 8 μm to 20 μm, or 10 μm to 18 μm. A positive electrode active material having this particle size range can be harmoniously mixed with other components within the positive electrode active material layer and can achieve high capacity and high energy density. The average particle diameter is measured with a particle size analyzer and may mean a diameter (D50) of particles with a cumulative volume of 50 volume % in the particle size distribution.

The positive electrode active material may be in the form of secondary particles made by agglomerating a plurality of primary particles, or may be in the form of a single crystal. Additionally, the positive electrode active material may be spherical or close to a spherical shape, or may be polyhedral or irregular.

The positive electrode active material may be included in an amount of 55 wt % to 99.7 wt %, for example 74 wt % to 89.8 wt % based on a total weight of the positive electrode active material layer. Within the above range, the capacity of the rechargeable lithium battery can be maximized and cycle-life characteristics can be improved.

The binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

An amount of the binder in the positive electrode active material layer may be approximately 1 wt % to 5 wt % based on a total weight of the positive electrode active material layer.

The conductive material is included to provide electrode conductivity and any electrically conductive material may be used as a conductive material unless it causes a chemical change in a battery and examples of the conductive material include a carbon-based material such as natural graphite, artificial graphite, carbon black, acetylene black, ketjen black, a carbon fiber, a carbon nanofiber, carbon nanotube, and the like; a metal-based material of a metal powder or a metal fiber including copper, nickel, aluminum silver, and the like; a conductive polymer such as a polyphenylene derivative; or a mixture thereof. An amount of the conductive material in the positive electrode active material layer may be 1 wt % to 5 wt % based on a total weight of the positive electrode active material layer.

### Negative Electrode

In a rechargeable lithium battery, the negative electrode includes a current collector and a negative electrode active material layer on the current collector. The negative electrode active material layer includes a negative electrode active material and may further include a binder and/or a conductive material.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), and the Sn-based negative electrode active material may be Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these may be mixed with SiO₂. The elements Q and R may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

For example, the silicon-carbon composite may be a silicon-carbon composite including a core including crystalline carbon and silicon particles and an amorphous carbon coating layer on the surface of the core. The crystalline carbon may be artificial graphite, natural graphite, or a combination thereof. A precursor of the amorphous carbon may be coal-based pitch, mesophase pitch, petroleum-based pitch, coal-based oil, petroleum-based heavy oil, or polymer resin such as phenol resin, furan resin, and polyimide resin. At this time, an amount of silicon may be 10 wt % to 50 wt % based on a total weight of the silicon-carbon composite. In addition, the amount of the crystalline carbon may be 10 wt % to 70 wt % based on the total weight of the silicon-carbon composite, and the amount of the amorphous carbon may be 20 wt % to 40 wt % based on the total weight of the silicon-carbon composite. Additionally, a thickness of the amorphous carbon coating layer may be 5 nm to 100 nm. The average particle diameter (D50) of the silicon particles may be 10 nm to 20 μm. The average particle diameter (D50) of the silicon particles may desirably be 10 nm to 200 nm. The silicon particles may exist in an oxidized form, and in this case, the atomic content ratio of Si:O in the silicon particles, which indicates a degree of oxidation, may be 99:1 to 33:67. The silicon particles may be SiOₓ particles, and in this case, the x range in SiOₓ may be greater than 0 and less than 2.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed and used, the mixing ratio may be a weight ratio of 1:99 to 90:10.

An amount of the negative electrode active material in the negative electrode active material layer may be 95 wt % to 99 wt % based on a total weight of the negative electrode active material layer.

In an embodiment, the negative electrode active material layer further includes a binder and, optionally, may further include a conductive material. An amount of the binder in the negative electrode active material layer may be 1 wt % to 5 wt % based on the total weight of a negative electrode active material layer. In addition, when a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinylchloride, carboxylated polyvinylchloride, polyvinylfluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

Examples of the water-soluble binder may include a rubber binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluorine rubber, and a combination thereof. The polymer resin binder may be polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, it may further include a cellulose-based compound capable of imparting viscosity. The cellulose-based compound may be one or more types of carboxymethyl cellulose, hydroxypropylmethyl cellulose, methyl cellulose, or an alkali metal salt thereof. The alkali metal may be Na, K, or Li. An amount of the thickener used may be 0.1 to 3 parts by weight based on 100 parts by weight of the negative electrode active material.

The conductive material is included to provide electrode conductivity and any electrically conductive material may be used as a conductive material unless it causes a chemical change, and examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may be selected from a copper foil, a nickel foil, a stainless steel foil, a titanium foil, a nickel foam, a copper foam, a polymer substrate coated with a conductive metal, and a combination thereof.

### Electrolyte

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether-based solvent may be dibutyl ether, tetraglyme, diglyme, dimethoxyethane, 2-methyltetrahydrofuran, tetrahydrofuran, and the like and the ketone-based solvent may be cyclohexanone, and the like. In addition, the alcohol-based solvent may be ethyl alcohol, isopropyl alcohol, etc. and the aprotic solvent may be nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and the like.

The non-aqueous organic solvent may be used alone or in a mixture, and when the organic solvent is used in a mixture, the mixture ratio may be controlled in accordance with a desirable battery performance.

In addition, in the case of the carbonate-based solvent, a mixture of a cyclic carbonate and a chain carbonate may be used. In this case, when the cyclic carbonate and the chain carbonate are mixed in a volume ratio of about 1:1 to about 1:9, the electrolyte solution may exhibit excellent performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be used.

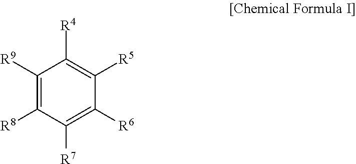

In Chemical Formula I, R⁴ to R⁹ are the same or different and are selected from hydrogen, a halogen, a C1 to C10 alkyl group, a haloalkyl group, and a combination thereof.

Specific examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte solution may further include vinylene carbonate or an ethylene carbonate-based compound of Chemical Formula II in order to improve cycle-life of a battery.

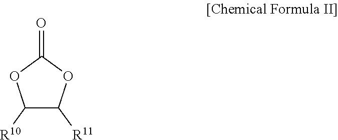

In Chemical Formula II, R¹⁰ and R¹¹ are the same or different, and are selected from hydrogen, a halogen, a cyano group, a nitro group, and a fluorinated C1 to C5 alkyl group, provided that at least one of R¹⁰ and R¹¹ is selected from a halogen, a cyano group, a nitro group, and a fluorinated C1 to C5 alkyl group, but both of R¹⁰ and R¹¹ are not hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within an appropriate range.

The lithium salt dissolved in the non-aqueous organic solvent supplies lithium ions in a battery, enables a basic operation of a rechargeable lithium battery, and improves transportation of the lithium ions between positive and negative electrodes.

Examples of the lithium salt include at least one selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer ranging from 1 to 20, lithium difluoro(bisoxalato) phosphate, LiCl, LiI, LiB(C₂O₄)₂ (lithium bis(oxalato) borate, LiBOB), and lithium difluoro(oxalato)borate (LiDFOB).

The lithium salt may be used in a concentration ranging from 0.1 M to 2.0 M. If the lithium salt is included at the above concentration range, an electrolyte may have excellent performance and lithium ion mobility due to optimal electrolyte conductivity and viscosity.

The separator 113, also called a separator, a positive electrode 114 and a negative electrode 112 and provides a transporting passage for lithium ions and may be any generally-used separator in a lithium ion battery. In other words, it may have low resistance to ion transport and excellent impregnation for an electrolyte solution. For example, it may include, for example, glass fiber, polyester, polyethylene, polypropylene, polytetrafluoroethylene, or a combination thereof, and may be in the form of a non-woven or woven fabric. For example, in a lithium ion battery, a polyolefin-based polymer separator such as polyethylene and polypropylene may be mainly used. In order to ensure the heat resistance or mechanical strength, a coated separator including a ceramic component or a polymer material may be used. Optionally, it may have a mono-layered or multi-layered structure.

Rechargeable lithium batteries may be classified as lithium ion batteries, lithium ion polymer batteries, and lithium polymer batteries according to the presence of a separator and the kind of electrolyte used in the battery. The rechargeable lithium batteries may have a variety of shapes and sizes, and include cylindrical, prismatic, coin, or pouch-type batteries, and may be thin film batteries or may be rather bulky in size. Structures and manufacturing methods for lithium ion batteries pertaining to this disclosure are well known in the art.

The rechargeable lithium battery according to an embodiment may be used in an electric vehicle (EV), a hybrid electric vehicle such as a plug-in hybrid electric vehicle (PHEV), and portable electronic device because it implements a high capacity and has excellent storage stability, cycle-life characteristics, and high rate capability at high temperatures.

### MODE FOR INVENTION

Hereinafter, examples of the present invention and comparative examples are described. It is to be understood, however, that the examples are for the purpose of illustration and are not to be construed as limiting the present invention.

### Example 1

### 1. Manufacturing of Separator

2.84 wt % of boehmite having an average particle diameter (D50) of 0.65 μm (BG611, Anhui Estone Co., Ltd.), 11.34 wt % of polyethylene wax having an average particle diameter (D50) of 1.2 μm (PMD-01, Nanjing Tianshi New Material Technologies Co., Ltd.), 0.58 wt % of a polyvinylpyrrolidone-acrylic acid-based copolymer having a molecular weight (M_{w}) of 300,000 and including 10 mol % of acrylic acid, 0.058 wt % of ethylene glycol diglycidylether as a crosslinking agent, 0.25 wt % of polyvinyl alcohol having a molecular weight (M_{w}) of 22,000 (Daejeong Chemical Co., Ltd.), and 84.932 wt % of a distilled water solvent are mixed to prepare a safety functional layer composition.

In addition, 4.72 wt % of a PVdF binder (SOLEF® XPH-838, Solvay S.A.), 1.57 wt % of an acrylic binder (BM-2510, ZEON Chemicals L.P.), 0.21 wt % of polyvinyl alcohol (Daejeong Chemical Co., Ltd.), and 93.5 wt % of a distilled water solvent are mixed to prepare an adhesive layer composition. Herein, the acrylic binder and the fluorine-based binder in the adhesive layer composition has a weight ratio of 1:3.

The safety functional layer composition is bar-coated on both of the surfaces of a polyethylene porous substrate with a thickness of about 5.5 μm (NW05535, CZMZ Corp.) and then, dried at about 80° C. to form a 2 μm thick safety functional layer on each surface. On the safety functional layer, the adhesive layer composition is bar-coated to form a 0.5 μm-thick adhesive layer on each surface, manufacturing a coated separator having a total thickness of 10.5 μm.

### 2. Manufacturing of Battery Cells

96 wt % of a LiCoO₂ positive electrode active material, 2 wt % of a polyvinylidene fluoride binder, 2 wt % of a carbon nanotube conductive material, and an N-methylpyrrolidone solvent are mixed with a mixer to prepare a positive electrode active material layer composition, and the positive electrode active material layer composition is coated on an aluminum foil and then, dried and compressed, manufacturing a positive electrode.

97 wt % of graphite, 1.5 wt % of a styrene butadiene rubber binder, 1.5 wt % of carboxylmethyl cellulose, and a distilled water solvent are mixed to prepare a negative electrode active material layer composition, and the negative electrode active material layer composition is coated on a copper current collector and then, dried and compressed, manufacturing a negative electrode.

A rechargeable lithium battery cell is manufactured by interposing the prepared coated separator between the positive electrode and the negative electrode, inserting it into a pouch-shaped battery case, and then injecting an electrolyte solution. The electrolyte solution is a solution of 1.1M LiPF₆ dissolved in a solvent mixed with ethylene carbonate (EC) and ethylmethyl carbonate (EMC) in a volume ratio of 3:5.

### Example 2

A coated separator and a battery cell are manufactured in the same manner as in Example 1 except that the weight ratio of the acrylic binder and the fluorine-based binder in the adhesive layer composition of the separator is designed to be 1:1 by using 3.15 wt % of the acrylic binder and 3.15 wt % of the PVdF binder.

### Example 3

A coated separator and a battery cell are manufactured in the same manner as in Example 1 except that the weight ratio of the acrylic binder and the fluorine-based binder in the adhesive layer composition of the separator is designed to be 1:4 by using 1.26 wt % of the acrylic binder and 5.03 wt % of the PVdF binder.

### Example 4

A coated separator and a battery cell are manufactured in the same manner as in Example 1 except that the weight ratio of the acrylic binder and the fluorine-based binder in the adhesive layer composition of the separator is designed to be 1:5 by using 1.05 wt % of the acrylic binder and 5.24 wt % of the PVdF binder.

### Comparative Example 1

A coated separator and a battery cell are manufactured in the same manner as in Example 1 except that the polyvinylpyrrolidone-acrylic acid-based copolymer and the crosslinking agent are not used, but 0.638 wt % of carboxylmethyl cellulose sodium salt (medium viscosity, Sigma-Aldrich Corporation) is used.

In manufacturing the coated separator of Comparative Example 1, there is a phenomenon that the safety functional layer is detached during the process of coating the adhesive layer. Accordingly, the final coated separator of Comparative Example 1 has the adhesive layer alone coated on both surface of the porous substrate.

### Evaluation Example 1: Evaluation of Resistance Characteristics

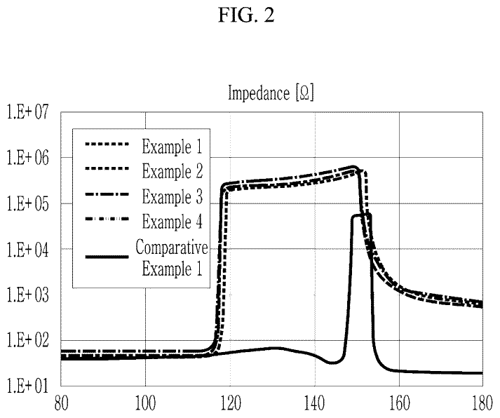

Each of the coated separators according to Examples 1 to 4 and Comparative Example 1 are measured with respect to resistance changes according to a temperature, while increasing the temperature at 10° C./min, after mounting a temperature sensor and a resistance-measuring meter thereon and placing it in a temperature variable chamber, and the results are shown in FIG. 2.

In FIG. 2, a rapid increase in resistance indicates that polyethylene particles of the safety functional layer melt and block an ion migration path, causing a shutdown. Referring to FIG. 2, in Comparative Example 1, the shutdown occurs at about 148° C., but in Example 1 to 4, the shutdown earlier occurs at about 123° C. than in Comparative Example 1. The shutdown temperatures of Examples 1 to 4 and Comparative Example 1 are shown in Table 1.

### Evaluation Example 2: Wet Electrode Adhesive Force

Each of the battery cells of Examples 1 to 4 and Comparative Example 1 is disassembled to measure adhesive force between the positive electrode and the separator after taking away the negative electrode. After separating the separator and the positive electrode by about 15 mm and then, fixing the positive electrode to a lower grip and the separator to an upper grip, the two grips are pulled apart in the 180° direction to peel the positive electrode and the separator at 100 mm/min. A force required to peel them by 40 mm is 3 times measured to calculate their arithmetic mean, and the results are shown in Table 1.

Referring to Table 1, the adhesive force of each of the separators of Examples 1 to 4 to the electrode is higher than that of Comparative Example 1, and particularly, Examples 1 and 2 exhibit excellent adhesive force of 0.4 gf/mm or higher.

### Evaluation Example 3: Evaluation of Air Permeability

Each of the separators of Examples 1 to 4 and Comparative Example 1 is measured with respect to time taken for 100 cc of air to pass it at a constant pressure (0.05 MPa) by using an air permeability measuring device (Asahi Seiko Co., Ltd.). The time is five times measured to calculate their arithmetic mean, and the results are shown in Table 1.

Referring to Table 1, Comparative Example 1, because a non-curing aqueous binder is applied to a safety functional layer, is confirmed to exhibit relatively low air permeability, but the separators of Examples 1 to 4, even though a curable binder is introduced into a safety functional layer, are confirmed to exhibit excellent air permeability of 250 sec/100 cc or less.

### Evaluation Example 4: Measurement of Film Resistance

Each of the coated separators Examples 1 to 4 and the Comparative Example 1 is impregnated in an electrolyte solution prepared by dissolving 1.5 M LiPF₆ in a mixed solvent of ethylene carbonate, ethylmethyl carbonate, and dimethyl carbonate (in a volume ratio of 2/1/7), inserted into an aluminum foil electrode with a lead tab, and sealed in an aluminum pack to manufacture a test cell, and then, resistance (Ω) of this test cell is measured in an AC impedance method (measurement frequency: 100 kHz) at 20° C., and the film resistance results are shown in Table 1.

Referring to Table 1, the separators of Examples 1 to 4 are confirmed to maintain appropriate resistance of 0.4Ω or less.

TABLE 1

| | | Wet | | |
|---|---|---|---|---|
| | Shut-down | adhesive | Air | |
| | temperature | force | permeability | Resistance |
| | (° C.) | (gf/mm) | (sec/100 cc) | (Ω) |
| Example 1 | 123 | 0.472 | 174 | 0.26 |
| Example 2 | 123 | 0.678 | 224 | 0.356 |
| Example 3 | 123 | 0.334 | 169 | 0.241 |
| Example 4 | 123 | 0.269 | 163 | 0.224 |
| Comparative | 148 | 0.275 | 154 | 0.189 |
| Example 1 | | | | |

Referring to Table 1, Comparative Example 1, in which after a safety functional layer is detached from a separator, an adhesive layer alone is left both of the surfaces of a porous substrate, exhibits low air permeability and resistance but a high shutdown temperature of 148° C. due to the loss of the safety functional layer, which is disadvantageous for early shutdown, and wet adhesive force with an electrode is also deteriorated. On the contrary, the separators of Examples 1 to 4 exhibit a shutdown temperature of 123° C., at which the early shutdown is possible, to secure battery safety and also, exhibit improved wet adhesive force with an electrode to secure stable long cycle-life and also, despite the safety functional layer and the adhesive layer, excellent air permeability and low resistance.

### Evaluation Example 5: Cycle-Life Characteristics

The cells of Examples 1 to 4 and Comparative Example 1 are charged to an upper limit voltage of 4.3 V at a constant current of 0.1 C and discharged to a discharge cut-off voltage of 3.0 V at the constant current of 0.1 C at 25° C. to proceed with initial charge and discharge. Subsequently, the cells are 280 times repeatedly charged and discharged within a voltage range of 3.0 V to 4.3 V at 1 C to calculate a ratio of discharge capacity at the 280^{th} cycle to initial discharge capacity, which is shown as capacity retention. Example 1 exhibits the 280^{th} cycle capacity retention of 90%, and Comparative Example 1 also exhibits the 280^{th} cycle capacity retention of 90%. Accordingly, the cell of Example 1 is confirmed to exhibit equivalent cycle-life characteristics to that of Comparative Example 1 to which CMC, an aqueous binder, is applied.

### Evaluation Example 6: Evaluation of Bending Safety

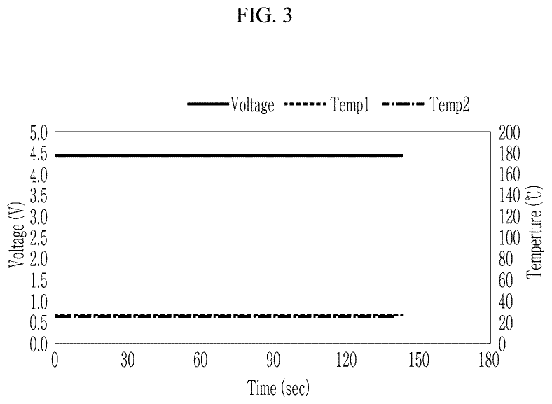

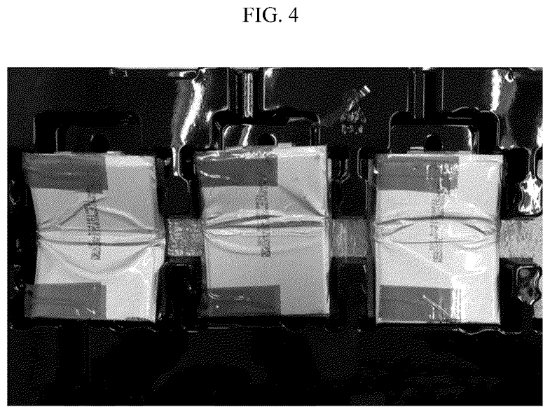

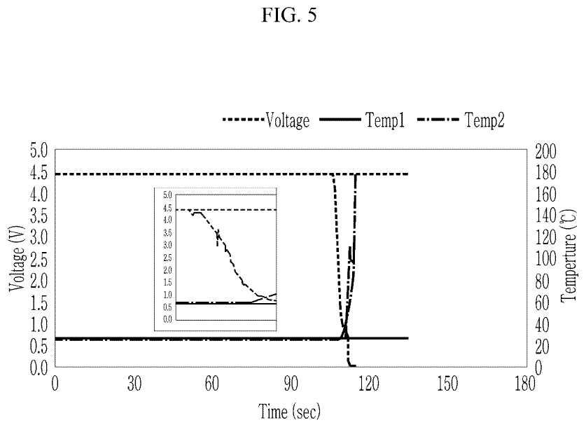

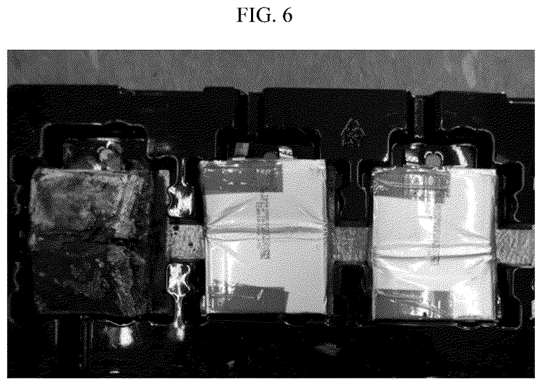

The cells of Examples 1 to 4 and Comparative Example 1, which are fully charged to an upper limit voltage of 4.3 V at a constant current of 0.1 C, are subjected to safety evaluation by bending it at 90° with a load of 100 N. The result of Example 1 is shown in FIGS. 3 and 4, and the result of Comparative Example 1 is shown in FIGS. 5 and 6. FIGS. 3 and 5 are graphs showing changes in voltage and temperature over time, and FIGS. 4 and 6 are photographs of battery cell samples after completing the bending safety evaluation.

Referring to FIGS. 3 and 4, Example 1 exhibits neither voltage changes nor temperature changes and no problems such as explosion or firing, etc. in the bending evaluation. This means that the safety functional layer and the adhesive layer may be respectively coated with excellent quality without the problems such as collapse or detachment of the safety functional layer due to coating of the adhesive layer, that a thermally expandable polymer such as polyethylene particles and the like, is sufficiently bonded by an aqueous crosslinked binder in the safety functional layer to achieve excellent slip characteristics between the separator substrate and the thermally expandable polymer and between the thermally expandable polymers, and in addition, that there is no problem such as explosion and the like due to a low shutdown temperature in the bending safety evaluation.

On the contrary, referring to FIGS. 5 and 6, Comparative Example 1 exhibits a sharp temperature decrease and voltage increase at about 100 seconds and is confirmed that one of the samples is exploded. This is understood that there is no satisfactory coating result due to an adhesive layer composition, such as detachment of a safety functional layer and the like during formation of an adhesive layer, which leads to the unsatisfactory result in the safety evaluation.

Although the preferred embodiments have been described in detail above, the scope of the present invention is not limited thereto. In addition, various modifications and improvements made by those skilled in the art using the basic concept defined in the claims should also be understood as falling within the scope of the present invention.

(Description of Symbols)

100: rechargeable lithium battery
112: negative electrode
113: separator
114: positive electrode
120: battery case
140: sealing member

1. A separator for a rechargeable lithium battery, comprising
a porous substrate;
a safety functional layer on at least one surface of the porous substrate; and
an adhesive layer on the safety functional layer;
wherein the safety functional layer includes polymer particles having a melting point of 100° C. to 200° C., an aqueous crosslinked binder, and inorganic particles,
the aqueous crosslinked binder includes a crosslinked product of a poly(vinyl amide)-based copolymer, and
the poly(vinyl amide)-based copolymer includes a unit derived from a vinyl amide monomer and a unit derived from a monomer including a crosslinkable group.

2. The separator for a rechargeable lithium battery as claimed in claim 1, wherein in the safety functional layer, the polymer particles having the melting point of 100° C. to 200° C. comprise at least one of polyolefin, polystyrene, ethylene-vinyl acetate copolymer, ethylene-acrylic acid copolymer, ethylene-methacrylic acid copolymer, polytetrafluoroethylene, polyamide, polyacrylonitrile, thermoplastic elastomer, polyethyleneoxide, polyacetal, thermoplastic modified cellulose, polysulfone, a (meth)acrylate copolymer, polymethyl(meth)acrylate, and a copolymer thereof.

3. The separator for a rechargeable lithium battery as claimed in claim 1, wherein in the safety functional layer, the polymer particles having the melting point of 100° C. to 200° C. have an average particle diameter (D50) of 50 nm to 5 μm.

4. The separator for a rechargeable lithium battery as claimed in claim 1, wherein in the aqueous crosslinked binder of the safety functional layer, the vinylamide monomer is selected from vinylpyrrolidone, vinylcaprolactam, N-vinylformamide, N-vinylacetamide, N-vinyl-N-methylacetamide, and a mixture thereof.

5. The separator for a rechargeable lithium battery as claimed in claim 1, wherein in the aqueous crosslinked binder of the safety functional layer, the crosslinkable group of the unit derived from the monomer including the crosslinkable group is at least one selected from a carboxyl group, an amine group, an isocyanate group, a hydroxy group, an epoxy group, and an oxazoline group.

6. The separator for a rechargeable lithium battery as claimed in claim 1, wherein in the aqueous crosslinked binder of the safety functional layer, the monomer including a crosslinkable group is carboxylic acid and the carboxylic acid is selected from acrylic acid, methacrylic acid, carboxylethylacrylate, carboxylpentylacrylate, itaconic acid, maleic acid, fumaric acid, crotonic acid, isocrotonic acid, a monovalent metal salt of these acids, a divalent metal salt, an ammonium salt, an organic amine salt, and a mixture thereof.

7. The separator for a rechargeable lithium battery as claimed in claim 1, wherein in the aqueous crosslinked binder of the safety functional layer, the unit derived from the monomer including the crosslinkable group is included in an amount of greater than 0 mol % and less than 50 mol % based on 100 mol % of the poly(vinyl amide)-based copolymer.

8. The separator for a rechargeable lithium battery as claimed in claim 1, wherein in the aqueous crosslinked binder of the safety functional layer, the poly(vinyl amide)-based copolymer includes a vinylpyrrolidone-derived unit and (meth)acrylic acid-derived unit.

9. The separator for a rechargeable lithium battery as claimed in claim 1, wherein in the aqueous crosslinked binder of the safety functional layer, the crosslinked product of the poly(vinyl amide)-based copolymer is crosslinked by a crosslinking agent, and the crosslinking agent is at least one selected from ethylene glycol diglycidyl ether, polyethylene glycol diglycidyl ether, glycerol polyglycidyl ether, propylene glycol diglycidyl ether, polypropylene glycol diglycidyl ether, ethylene glycol, Diethylene glycol, propylene glycol, triethylene glycol, tetraethylene glycol, propane diol, dipropylene glycol, polypropylene glycol, glycerin, polyglycerin, butanediol, heptanediol, hexanediol, trimethylene propane, pentaerythritol, and sorbitol.

10. The separator for a rechargeable lithium battery as claimed in claim 9, wherein an amount of the crosslinking agent is 1 to 45 parts by weight based on 100 parts by weight of the poly(vinyl amide)-based copolymer.

11. The separator for a rechargeable lithium battery as claimed in claim 1, wherein in the safety functional layer, the inorganic particles include at least one selected from boehmite, alumina, zirconia, yttria, ceria, magnesia, titania, silica, aluminum carbide, titanium carbide, tungsten carbide, boron nitride, aluminum nitride, calcium carbonate, barium sulfate, aluminum hydroxide, and magnesium hydroxide.

12. The separator for a rechargeable lithium battery as claimed in claim 1, wherein an average particle diameter (D50) of the inorganic particles in the safety functional layer is 50 nm to 2 μm.

13. The separator for a rechargeable lithium battery as claimed in claim 1, wherein based on 100 wt % of the safety functional layer,
the safety functional layer includes 40 wt % to 90 wt % of the polymer particles having the melting point of 100° C. to 200° C.;
0.1 wt % to 20 wt % of the aqueous crosslinked binder; and
5 wt % to 40 wt % of the inorganic particles.

14. The separator for a rechargeable lithium battery as claimed in claim 1, wherein the safety functional layer further includes an aqueous non-crosslinked binder.

15. The separator for a rechargeable lithium battery as claimed in claim 14, wherein the aqueous non-crosslinked binder includes at least one selected from polyvinyl alcohol, polyvinylacetate, polyacrylic acid, polyacrylic acidester, polymethacrylic acid, polymethacrylic acid ester, poly-N-vinylcarboxylic acidamide, polyacrylonitrile, polyether, polyamide, ethylenevinylacetate copolymer, polyethyleneoxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxylmethyl cellulose, acrylonitrile styrene butadiene copolymer, and polyimide.

16. The separator for a rechargeable lithium battery as claimed in claim 14, wherein the safety functional layer includes 40 wt % to 90 wt % of the polymer particles having the melting point of 100° C. to 200° C.;
0.1 wt % to 15 wt % of the aqueous crosslinked binder;
5 wt % to 40 wt % of the inorganic particles; and
0.1 wt % to 10 wt % of the aqueous non-crosslinked binder based on 100 wt % of the safety functional layer.

17. The separator for a rechargeable lithium battery as claimed in claim 1, wherein the adhesive layer includes at least one of an acrylic binder, a fluorine-based binder, and a polyvinyl alcohol binder.

18. The separator for a rechargeable lithium battery as claimed in claim 17, wherein the adhesive layer includes an acrylic binder and a fluorine-based binder, and a weight ratio of the acrylic binder and the fluorine-based binder is 1:1 to 1:6.

19. The separator for a rechargeable lithium battery as claimed in claim 17, wherein the acrylic binder is a (meth)acrylate-acetate copolymer, and the fluorine-based binder is selected from polyvinylidene fluoride, polyvinylidene fluoride-hexafluoropropylene, polyvinylidene fluoride-trichloroethylene, polyvinylidene fluoride-chlorotrifluoroethylene, and a mixture thereof.

20. A rechargeable lithium battery, comprising
a positive electrode,
a negative electrode,
the separator as claimed in claim 1 between the positive electrode and the negative electrode, and
an electrolyte.
